(19) United States
(12) Patent Application Publication
(10) Pub. No.: US 2010/0306044 A1
(43) Pub. Date: Dec. 2, 2010

(54) SYSTEM AND METHOD FOR REPORTING ADVERTISING METRIC DATA

(76) Inventors: Gaelle C. Martin-Cocher, Mississauga (CA); Brian McColgan, Mississauga (CA)

Correspondence Address: Research in Motion Corp./Q&B;Attn: Glenda Wolfe, Bldg. 6, Brazos East, Suite 100, 5000 Riverside Drive, Irving, TX, 75039, US

(21) Appl. No.: 12/785,088

(22) Filed: May 21, 2010

Related U.S. Application Data
(60) Provisional application No. 61/181,168, filed on May 26, 2009.

(51) Int. Cl. G06Q 30/00; G06Q 10/00

(52) U.S. Cl. 705/14.41

(57) ABSTRACT

A method comprising the steps of using a processor running a program to perform the step of receiving, at an advertising entity, a report message containing an identifier of an application which presented advertisements, and a data structure with metrics for the advertisements which were presented by the application.

The present application claims priority to U.S. patent application No. 61/181,168 which was filed on May 26, 2009 and which is titled “System and Method for Reporting Advertising Metric Data”.

### FIELD OF THE INVENTION

The present invention relates to a method and apparatus for tracking advertisements in communication systems that employ wireless electronic devices. More particularly, the present invention relates to a method and system for reporting advertising metrics associated with specific applications.

### BACKGROUND OF THE INVENTION

Advertisers are always looking for ways to customize advertisements for potential customers. Personal electronic devices have made customized advertising possible in many ways. To this end, a web browser running on a portable electronic device such as a hand held computer, cell phone, etc., may track content viewed or otherwise consumed by a device user and use that information to customize advertisements presented to the user. In addition, when advertisement(s) are presented to a user via a browser or the like, the user's responses (i.e., selection of the advertisement, purchase of a good or service through an advertisement, etc.) to the advertisement(s) can be tracked and used to subsequently market other goods and/or services to the user.

Moreover, costs for advertising can be assigned to specific advertisers where the extent of advertising and/or effectiveness of advertising can be tracked. Thus, an advertiser may be charged by the number of times an advertisement is presented to potential customers, the number of times potential customers click on an advertisement to obtain additional information, etc.

A typical electronic advertising system includes, in addition to the electronic devices which present the advertisement(s) to a user thereof, an Ad Server (e.g., an advertisement provider), one or more content provider servers and one or more service provider (SP) servers. The content provider servers provide advertisement content, and references to the content, to the Ad Server. The Ad Server stores and provides ads and ad references (e.g., network addresses) that can be used to access and retrieve advertisements. The SP servers cooperate with portable devices, in at least some cases, to provide services (e.g., news services, stock market trading services, sports update services, network browsing services, etc.) via Service Provider applications (SP Apps) to the devices.

At least some electronic devices include a processor that runs one or more applications and an Ad Engine where the applications access and render advertisements for a user at various times during the execution of different applications. Alternatively some electronic devices include one or more ad-aware applications where each ad-aware application is configured with advertisement logic. For instance, in the case of an application usable to access a video clip of a news story, in order to view the news story, a user may first be required to view an advertisement video clip presented by the application.

In many cases applications run advertisements that are at least somewhat related to content recently viewed via the device. In other cases where a device is position/location enabled (including a GPS, for example), ad content may be selected automatically by the Ad Engine at least based on the current location of the device. Still further, ad content may be selected according to a user profile that defines or establishes the user's interests, demographics, etc. Hereinafter, unless indicated otherwise, applications run by the device processor and that periodically present advertisements will be referred to as advertisement applications or “Ad Apps”.

The Ad Engine on the device performs several functions. First, the Ad Engine periodically obtains ads from the Ad Server that can be provided to Ad Apps on the device when needed. Second, the Ad Engine obtains or otherwise receives ad requests from the Ad Apps along with, in at least some cases, request qualifier information that can be used, by the Ad Engine, to select substantially optimal advertisements to be presented via the Ad App(s). For instance, where a user recently used the device to view a professional football team schedule, and one possible advertisement has something to do with the team associated with the viewed schedule, the Ad Engine may select the ad associated with the football team of interest to be presented via the Ad App. Third, in many systems, the Ad Engine may record and collect metrics related to which ads are presented to a user and the user's reactions to the ads, either based on heuristics or if an Ad App notifies the Ad Engine about the ad consumption. One example of the above method is described in the Open Mobile Alliance (OMA) Mobile Advertising (MobAd) Enabler. The OMA MobAd Enabler specifies the functionalities of advertising entities such as the Ad App, SP App, Ad Engine and Ad Server in addition to the architecture or relationships/interfaces between these entities.

In an electronic advertising system including a device with Ad Apps and an Ad Engine, Ad Server and an ad content provider, the Ad Server may receive and store a plurality of ad references from an ad content provider to be presented to a user at subsequent times. Thereafter, when an Ad App requests an ad, the Ad Engine selects an appropriate ad reference, which was previously provided by the Ad Server, and provides that reference to the Ad App. When the Ad App receives the ad reference, the Ad App uses the received ad reference to access the ad content provider to fetch the ad content which is then presented to the user via the device. In some cases ad content may be stored or cached locally on a portable device by the Ad Engine. In some case the Ad Engine may fetch the ad content in advance, on behalf of Ad Apps. In this case, when an Ad App requests an ad, the Ad Engine selects an appropriate ad and provides the ad content to the Ad App which then presents the ad to the user via the device.

The Ad App tracks presentation and interaction with the ad and reports metrics associated therewith to the Ad Engine. The Ad Engine is also capable of tracking interactions with ads that were provided to the Ad App as well as ads that were not provided to the Ad App (e.g., for whatever reason). The Ad Engine centralizes the metrics. One metric may be as simple as tracking the number of times each ad is presented via a device. More complex metrics may include times when ads are presented, device user interaction with ads (e.g., via selection of a link in the ad, etc.), device location when an ad is presented (e.g., was the device proximate a restaurant when an advertisement was presented, etc.). This list of metrics is only exemplary and many other metrics may be employed.

In instances where a portable device does not include an Ad Engine, a service provider (SP) may perform several of the tasks typically performed by the Ad Engine while simultaneously cooperating with a user agent device to perform SP Apps. An exemplary SP App may include a news service that serves up news to a portable device when employed along with other services that are combined into a multi-service application. As an SP server runs an SP App, each application service periodically request advertisements. In response to the requests, the SP server selects an appropriate ad for a specific device and provides the ad or an ad reference to the requesting SP App service. As in the case of the Ad Engine, an SP App may cache ads for subsequent use. The SP App service may embed ads in content to be provided to the device and then transmit the content and advertisement or ad reference to the device to be presented to a user.

If a device user views the ad and selects a link therein to obtain additional information, a request for additional information associated with the ad is transmitted to the SP App which in turn bundles the additional information which is transmitted back to the device as content. Additional ads may be embedded in the new content for viewing by the device user. The service associated with the new content may either be the prior service employed or a new service associated with the SP App. When a user interacts with either content or an advertisement so that a new transmission to the SP App occurs, the service provider server can be programmed to recognize or detect that a newly received transmission from the device indicates that the ad has been viewed by the device user. This metric along with various other metrics may be stored by the SP App to be subsequently reported to the Ad Server.

Ad metrics are reported from an Ad Engine or an SP App to an Ad Server in the form of a Metrics Report. The Ad Server may use reported metrics to assign or subsequently bill advertisement costs to specific ad providers. An exemplary Metrics Report generated by an Ad Engine (i.e., an “Ad Engine Metrics Report”) includes an Ad Engine identifier and ad metrics information associated with each ad presented to an associated device. The ad metrics information includes an ad identifier indicating the identity of a specific ad that was presented, the identities of Metrics Reported in a list of strings and a separate value for each of the reported metrics. For instance, a report may indicate Ad Engine 001019933 associated with a specific device, ad 003, metrics 3, 10 and 15 and metric values 22, 5 and 7 that correspond to metrics 3, 10 and 15, respectively. That is, in this example the report contains metrics related to a single advertisement, “ad 003.” Such reports are considered to be generated, constructed or otherwise configured on a “per ad” basis.

An exemplary Metrics Report generated by an SP App (i.e., an “SP App Metrics Report”) includes information on a per ad basis which may be similar to the Ad Engine Metrics Report described above. The SP App provides SP App Metrics Reports for advertisements, services or applications provided to a user on a device not making use of an Ad Engine. For instance, an exemplary SP App Metrics Report includes an SP App identifier, an ad identifier, the identities of Metrics Reported, and a separate value for each of the reported metrics.

While current per ad Metrics Reports are suitable for tracking advertisements and generating billing information for assigning advertisement costs to different advertisers (e.g., based on how many times a particular ad was presented), the information in current reports has several shortcomings. For instance, current report information cannot be used to associate advertisement revenue with application and service providers that provide the content and applications to device users because current per ad Metrics Reports do not contain information which, for example associates ads with the application(s) that presented those ads. In addition, current report information cannot be used to develop subsequent targeted advertisement campaigns where the targeting criteria is directly linked to effectiveness of certain application/advertisement combinations.

### BRIEF DESCRIPTION OF THE DRAWINGS

The invention will hereafter be described with reference to the accompanying drawings, wherein like reference numerals denote like elements, and:

FIG. 1 is a schematic diagram illustrating an exemplary communication system that may be employed for at least some aspects of the present invention;

FIG. 2 is a schematic diagram illustrating exemplary components of the user agent device shown in FIG. 1;

FIG. 3 is a schematic diagram illustrating exemplary components of the Ad Engine shown in FIG. 2;

FIG. 4 is a schematic diagram illustrating an exemplary communication sequence between an ad application, an Ad Engine, and an Ad Server according to at least some aspects of the present invention;

FIG. 5 is a schematic diagram illustrating an exemplary per-application Ad Engine Metrics Report format;

FIG. 6 is a schematic diagram illustrating a per-ad report format;

FIG. 7 is a schematic diagram illustrating exemplary components of the service provider database shown in FIG. 1;

FIG. 8 is a schematic diagram illustrating a communication sequence between the user agent, an Ad Server, and a service provider application according to at least some aspects of the present invention;

FIG. 9 is a schematic diagram illustrating an SP App metric data report format for reporting per service metrics; and

FIG. 10 is a schematic diagram illustrating a per ad report format.

### DETAILED DESCRIPTION

The present disclosure provides methods for tracking, reporting and using advertising metrics data on a per-functional process basis and the per-functional process metrics may be reported back to an Ad Server (e.g., an advertisement provider) as part of a Metrics Report. The Ad Server can then use the per-functional process ad metrics to divide up ad revenue per process provider and/or to develop new ways to measure ad effectiveness or select ads for presentation in conjunction with future functional processes.

It has also been recognized that a metric type field can be added to an existing and currently used metric report format that can render the existing format useful in transmitting multiple different ad metric report types. For instance, the metric type field may indicate a per-application or per-service ad metric type report on one hand or a per ad metric type report on the other hand, where the other report fields include different information types depending on which type of report is indicated. In this way an existing and generally accepted report format can be modified with a single field to yield a far more powerful reporting tool.

Consistent with the above, at least some embodiments of the disclosure include a method comprising receiving, at an advertising entity, a report message containing an identifier of an application which presented advertisements, and a data structure with metrics for the advertisements which were presented by the application. In some cases the advertising entity is an Ad Engine and the application is an Ad App as specified by the Open Mobile Alliance (OMA) Mobile Advertising (MobAd) enabler. In some cases the report message is an Ad App Metrics Report message. In some cases the method further includes communicating, to an Ad Server as specified by the Open Mobile Alliance (OMA) Mobile Advertising (MobAd) enabler, an Ad Engine Metrics Report message which includes information of the report message.

In some cases the communicating comprises creating a metric report by aggregating the information of the report message with additional metric data and sending the Ad Engine Metrics Report message which includes the metric report.

In some embodiments the additional metric data is from one of another application which presented advertisements, the Ad Engine and a component of a device on which the Ad Engine is configured. In some cases the advertising entity is an Ad Server and the application is a service provider (SP) application (SP App) as specified by the Open Mobile Alliance (OMA) Mobile Advertising (MobAd) enabler. In some cases the report message is an SP App Metrics Report message.

Other embodiments include an electronic device comprising an advertising entity configured to receive a report message containing an identifier of an application which presented advertisements on the electronic device, and a data structure with metrics for the advertisements which were presented by the application.

In some cases the advertising entity is an Ad Engine and the application is an Ad App as specified by the Open Mobile Alliance (OMA) Mobile Advertising (MobAd) enabler. In some cases the report message is an Ad App Metrics Report message. In some cases the advertising entity is further configured to communicate, to an Ad Server as specified by the Open Mobile Alliance (OMA) Mobile Advertising (MobAd) enabler, an Ad Engine Metrics Report message which includes information of the report message.

In some cases the advertising entity, when communicating, performs operations of creating a metric report by aggregating the information of the report message with additional metric data and sending the Ad Engine Metrics Report message which includes the metric report.

In some cases the additional metric data is from one of: another application which presented advertisements; the Ad Engine; and a component of a device on which the Ad Engine is configured. In some cases the advertising entity is an Ad Server and the application is a service provider (SP) application (SP App) as specified by the Open Mobile Alliance (OMA) Mobile Advertising (MobAd) enabler. In some cases the report message is an SP App Metrics Report message.

Other embodiments include a method comprising receiving, at an advertising server from an advertising engine on an electronic device, a report message containing an identifier of an application on the electronic device which presented advertisements, and a data structure with metrics for the advertisements which were presented by the application.

In some cases the advertising server is an Ad Server as specified by the Open Mobile Alliance (OMA) Mobile Advertising (MobAd) enabler, wherein the advertising engine is an Ad Engine as specified by the OMA MobAd enabler, and wherein the application and the application is an Ad App as specified by the OMA MobAd enabler. In some cases the report message is an Ad Engine Metrics Report message.

Other embodiments include a network device comprising an advertising server configured to receive, from an advertising engine on an electronic device, a report message containing an identifier of an application on the electronic device which presented advertisements, and a data structure with metrics for the advertisements which were presented by the application.

In some cases the advertising server is an Ad Server as specified by the Open Mobile Alliance (OMA) Mobile Advertising (MobAd) enabler, wherein the advertising engine is an Ad Engine as specified by the OMA MobAd enabler, and wherein the application and the application is an Ad App as specified by the OMA MobAd enabler. In some cases the report message is an Ad Engine Metrics Report message.

The various aspects of the subject invention are now described with reference to the accompanying drawings. It should be understood, however, that the drawings and detailed description hereafter relating thereto are not intended to limit the claimed subject matter to the particular form disclosed. Rather, the intention is to cover all modifications, equivalents, and alternatives falling within the spirit and scope of the claimed subject matter.

As used herein, the terms “component,” “system” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a computer and the computer can be a component. One or more components may reside within a process and/or thread of execution and a component may be localized on one computer and/or distributed between two or more computers or processors.

The word “exemplary” is used herein to mean serving as an example, instance, or illustration. Any aspect or design described herein as “exemplary” is not necessarily to be construed as preferred or advantageous over other aspects or designs.

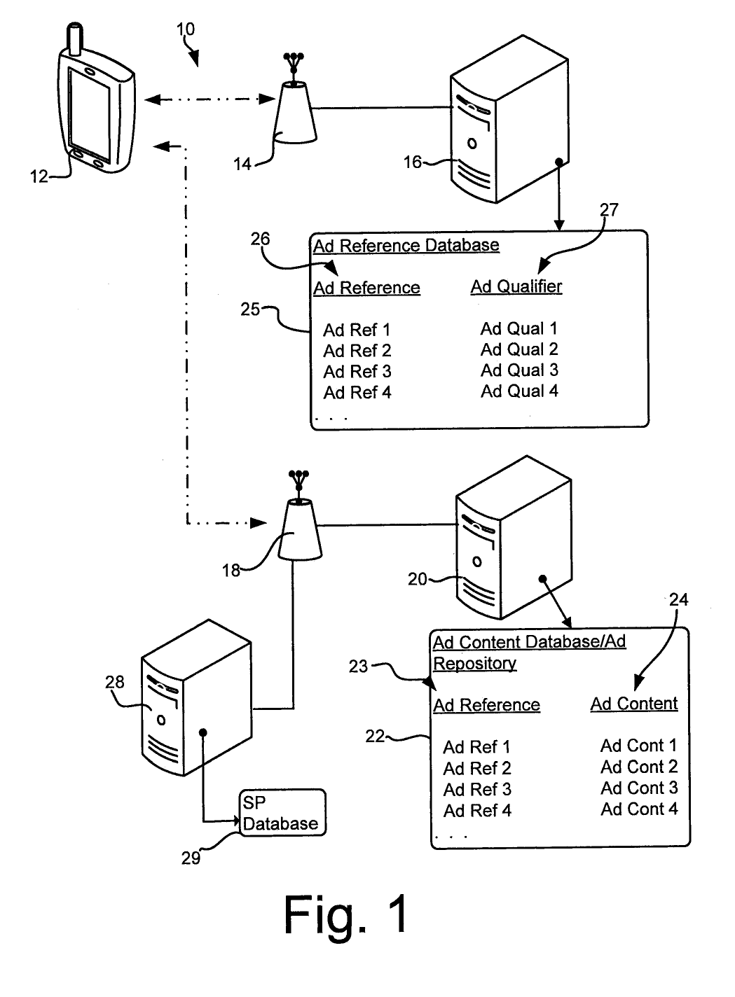

Referring now to the figures, systems, methods and apparatuses for facilitating advertising metric reporting are illustrated. As shown in FIG. 1, an exemplary communication system 10 includes a user agent 12, wireless network access devices 14, 18, an Ad Server 16, and a service provider (SP) server 28. User agent 12, also referred to as “UA”, may be a wireless device such as a mobile telephone, a personal digital assistant, handheld or lap top computers, or similar devices that have telecommunications capabilities. In some embodiments UA 12 may be a mobile wireless device. In other embodiments UA 12 may be a device that is not transportable such as a desktop computer, a set top box or a network node. Similarly, at least one of the Ad Server 16 and the SP server 28 may be a computing device (e.g., network device or network component) which is executing server operations, behaviors or methods.

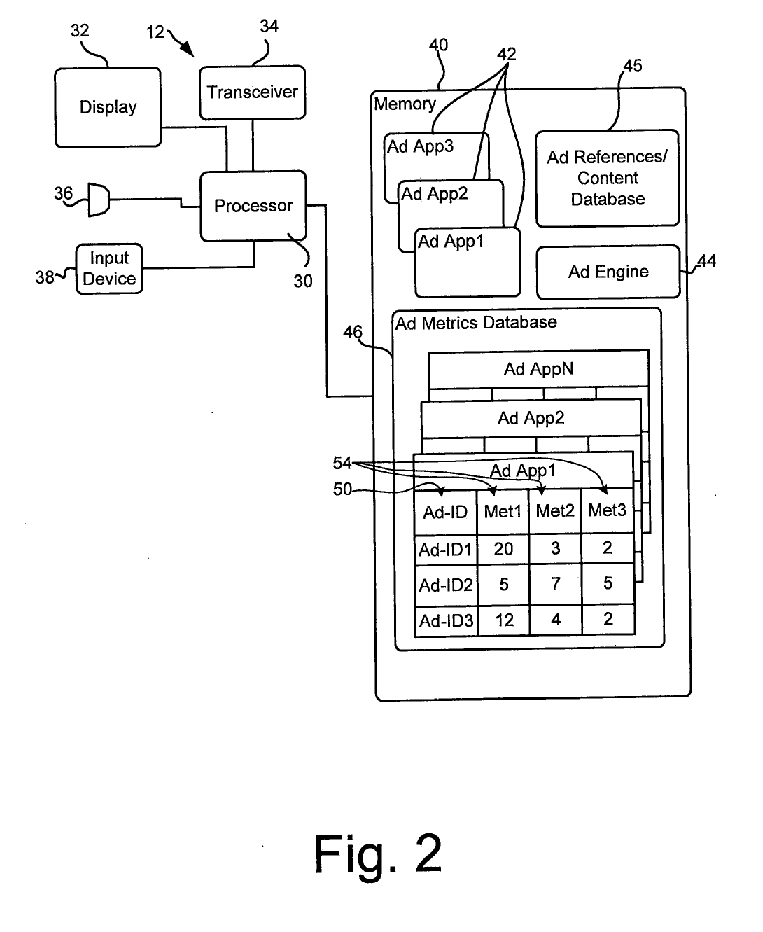

Referring now to FIG. 2, the components that comprise an exemplary UA 12 are illustrated. Exemplary UA 12 includes a processor 30, an electronic display device 32, a transceiver 34, an audio component 36, (e.g., a speaker), an input device 38 and a memory 40. Processor 30 is linked to display 32 and audio component 36 for providing output to a UA user. Some output to a user includes advertisements in the form of video clips and/or still images, virtual control, sensor control and/or selection buttons for controlling advertisements, etc. Processor 30 is also linked to input device 38 for receiving input from a UA user. Input device 38 may take any of several different forms including a button or buttons, a switch or switches, a keyboard, trackball, roller wheel, motion sensor, etc., or virtual buttons presented on the display screen 32 that are selectable via a controlled cursor or by touching the electronic display device 32. Processor 30 is further linked to transceiver 34 and memory 40.

Processor 30 executes various application programs (hereinafter referred to as Ad Apps). Some of the Ad Apps may include an on-device portal, games, a music application, etc. Transceiver 34 enables wireless reception and transmission of data between UA 12 and access devices (e.g., 14 and 18 in FIG. 1).

Referring still to FIG. 2, memory 40 stores several different types of information including a plurality of Ad Apps collectively identified by reference numeral 42 that are run by processor 30. In addition, memory 40 stores an Ad Engine 44, a local ad references/content database 45, and ad metrics database 46.

Referring again to FIG. 1, network access devices 14 are transponders or transceivers that receive wirelessly transmitted data from UA 12 and wirelessly transmit data and information to UA 12. Ad content provider server 20, as the name implies, is configured as a server that stores ad content including audio and video data that may be provided to UA 12 via access device 18. Ad content may be stored in a data structure such as the ad content database/ad repository 22 shown in FIG. 1. Database/repository 22 is illustrated in table format in order to simplify this explanation. Nevertheless, it should be understood that the ad content database/ad repository 22 may take any form known in the art (e.g., relational database, lookup table, XML Document with an associated XML Schema, etc.) and, in many cases, may be more complex than the table database 22 illustrated.

Exemplary database 22 includes an ad reference column 23 and an ad content column 24. Ad reference column 23 lists references that can be used to access separate ads stored in database 22. Ad content column 24 includes a separate subset of ad content for each one of the ad references in column 23. Ad content includes data used to present audio and/or visual information to a UA 12 user and may include any format including text, graphics, etc. White database repository 22 is shown as separate from server 20 and, in some embodiments is simply managed by server 20, it should be appreciated that database/repository 22 may also be an integral part of server 20 or that server 20 may send advertisement request to distant server 22, corresponding to a variety of ad network, Ad Server providers. Although only a single content provider server 20 is shown, it should be appreciated that a typical advertising and communication system 10 may include a large number of separate content provider servers 20 where each server 20 is maintained by a different advertising entity.

Referring still to FIG. 1, Ad Server 16 maintains an ad reference database 25 which may store a collection (e.g., an extensive list) of ad references in column 26 from a plurality of the ad content provider databases (e.g., see 22 in FIG. 1). In this way the Ad Server 16 may be a proxy for one or more ad content provider servers 20. For example, where there are a predetermined number of (e.g., one hundred) different ad content provider servers 20 and associated ad content databases, the ad reference database 25 may store all of the ad references from each of the ad content databases 22 that comprise the system 10. In addition to storing ad references, the ad reference database 25 may also store information that groups the ad references into different categories, groups or channels corresponding to different general topics such as sports, automobiles, water craft, building materials, hobbies, electronics, computer, etc. Moreover, database 25 may store information regarding how often ads associated with the ad references should be presented to UA users, times during which ads should be presented (e.g., three hour period before and including lunch hour), UA locations at which ads should be presented, periods during which ads remain valid (i.e., “validity durations” of the ads), etc. In FIG. 1, an ad qualifier column 27 lists ad qualifiers for each of the ad references in column 25 where the qualifiers may include one or more times to present ads, locations at which to present ads, content type, topics, etc. Alternatively, Ad Server 16 may be a proxy to one or more ad networks (including remote ad networks) to reformulate ad requests and present those requests to various servers (e.g., 20) instead of storing a huge repository of ads/ad references. In this case, the Ad Server 16 may maintain references and associated qualifiers to Ad Content Databases/Repositories which may be associated with specific topics.

In some embodiments databases 22 and 25 may be included in a single database. Moreover, Ad Ref 1 in database 22 and Ad Ref 1 in database 25 may be different ad references. Furthermore, in at least some embodiments, Ad Ref 1 in database 25 may contain an ad path-link or reference (e.g., URL, URI, etc.) that points to Ad Server 16 or another final destination (e.g., the content provider server or Content XML Document Management System—XDMS 20) where ad content can be retrieved or otherwise obtained. Also server 25 may contain in some embodiments the ad content itself.

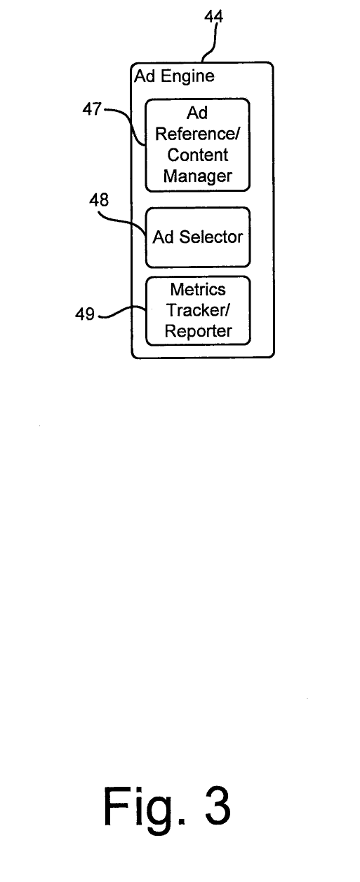

Referring now to FIG. 3, an exemplary Ad Engine 44 is illustrated that includes an ad Reference/Content Manager 47, an Ad Selector 48 and a metrics tracker/reporter 49. Ad Reference/Content Manager 47, in at least some embodiments, maintains a list of ads and ad references that can be used by UA 12 to obtain ad content. Periodically, the Ad Reference/Content Manager 47 will request one or more ad references/content from Ad Server 16 (see again FIG. 1) and, when those references are obtained, potentially along with associated ad qualifiers 27, stores those references and associated qualifiers in the ad reference database 45 (see also FIG. 2) for subsequent use.

Ad Engine 44 receives ad requests from ad applications (e.g., Ad App1, Ad App2, Ad App3, etc. shown in FIG. 2) run by processor 30 and, Ad Selector 48 as the name implies, selects ads to present to a UA 12 user. Ad requests may contain information related to user activities, location, content or other contextual information. The Ad Selector 48, in at least some embodiments, selects ads as a function of user activities performed most recently via the UA 12. Thus, for example, where a UA user recently accessed a professional football team schedule via the UA 12, Ad Selector 48 may select or qualify an advertisement related to sports or more specifically, an advertisement related to professional football or to the team associated with the schedule recently viewed. In addition, where UA 12 has positioning capabilities (e.g., by way of GPS or time and/or angle of arrival-based methods), Ad Selector 48 may select or qualify an ad to be presented to the UA user as a function of the substantially instantaneous location of the UA 12 when an application requests an ad. For instance, where a UA 12 is proximate to a restaurant, the selector 48 may use the position of the UA 12 to select an ad that is to be presented when a UA is near the restaurant. Ad Selector 48 may use many other types of data and situational information to select appropriate ads to be presented to the user.

Metrics tracker/reporter 49 tracks how many times specific ads are presented (i.e., tracks ad “impression(s)”) via a UA 12, how a UA user responds to an ad (e.g., did the user select (i.e., “click”) an ad to obtain additional information, did the user ignore or cancel the ad, etc.) and other types of metric information. The metrics tracker 49 receives metrics data information from Ad Apps and can track additional metrics data, such as ads received by the Ad Engine and never used or presented. The metrics tracker 49 can aggregate the metrics data from different sources. The metrics tracked by tracker 49 are stored in the ad metrics database 46 (FIG. 2) and are used to create various types of Ad Engine Metrics Reports. The Metrics Reports are periodically transmitted from UA 12 to Ad Server 16 in FIG. 1 or to some other server that can use the reports for ad billing purposes, assessing ad effectiveness, identifying user trends, etc.

Referring once again to FIGS. 1 and 2, in general, Ad Engine 44 periodically requests ads from Ad Server 16. Ad Server 16 returns ad references which, when received, are stored in the ad reference/content database 45. As processor 30 runs Ad Apps 42, periodically, the Ad Apps 42 are configured to present ads to the UA user via display 32 and/or audio component 36. When an ad is to be presented, an Ad App 42 requests an ad from Ad Engine 44. The Ad Engine 44 performs an ad selection operation and returns an ad reference/content to the Ad App 42. The Ad App 42 then uses the ad reference to obtain ad content associated with the ad reference or uses the ad content. The ad content may be obtained from one or more of the Ad Engine 44 itself, from the Ad Server 16, from one of the content provider servers 20 and from one of the service provider (SP App) servers 28. Once the ad content is received by an Ad App, the Ad App presents the ad to the user. When an Ad App uses an ad reference in an attempt to obtain ad content from a content provider, the ad-link path can pass through the Ad Engine 44 so that the metrics tracker/reporter 49 (FIG. 3) of the Ad Engine 44 can accurately track ads presented via UA 12.

Referring again to FIG. 2, an exemplary ad metrics database 46 is illustrated that includes ad metrics arranged by Ad App/Ad-ID combinations, that is on a “per app” basis which is different and distinct from the previously-mentioned “per ad” basis. Database 46 includes a separate table or data structure for each Ad App employed by UA 12 (FIG. 1) where the tables are labeled with different Ad App identifiers (e.g., Ad App1, Ad App2, etc.). Each Ad App table can be similarly constructed and may be employed in a similar fashion and therefore, in the interest of simplifying this explanation, only the Ad App1 table will be described here in detail. The Ad App1 table includes an Ad ID column 50 which lists a plurality of different ad identifiers Ad-ID1, Ad-ID2, Ad-ID3, etc., where each ad identifier corresponds to a different ad presented via the corresponding Ad App1.

In addition to Ad ID column 50, the Ad App1 table includes a plurality of metric columns, one column for each metric that is tracked for any one of the Ad IDs in Ad ID column 50. In FIG. 2, three metric columns are shown where the columns are collectively labeled via numeral 54. The metric columns may each correspond to any of several different ad metrics such as impressions, clicks by a user, information related to which of several selectable ad icons have been selected, etc. For instance, where the metric tracked in the first column Met1 defines impressions, the entry there below corresponding to Ad-ID1 indicates that the ad corresponding to Ad-ID1 was presented via Ad App1 twenty (20) times during a period tracked. Where the metric tracked in the Met2 column is clicks, the entry corresponding to Ad-ID1 indicates that for the twenty presentations of Ad-ID1 via Ad App1, there were three (3) clicks by the UA user. While relatively simple metrics are described here it should be appreciated that far more complex metrics may be employed and tracked. Similarly, while a relatively simple database 46 is illustrated and described, far more complex databases 46 may be employed.

According to at least one aspect of the present invention, metrics tracker/reporter 49 (FIG. 3) may be configured to periodically assemble Ad Engine Metrics Reports on a per application basis where the reports include at least some information about which applications presented which ads. These Metrics Reports may be stored, for example by the metrics tracker/reporter 49, on a computer readable storage medium which in some instances may be a tangible or intransitory medium such as optical (e.g., CD, DVD, etc.), magnetic (e.g., tape) or other memory known in the art. Here, the information indicating which applications presented the ads can be used to divide up revenue associated with different advertising campaigns. For instance, where a specific ad was presented 300 times by a first Ad App1 and 100 times each by second and third Ad Apps, respectively, via multiple UAs over a specified tracking period, ad revenue associated with the ad may be divided 60%, 20% and 20% between first, second and third Ad App providers, respectively.

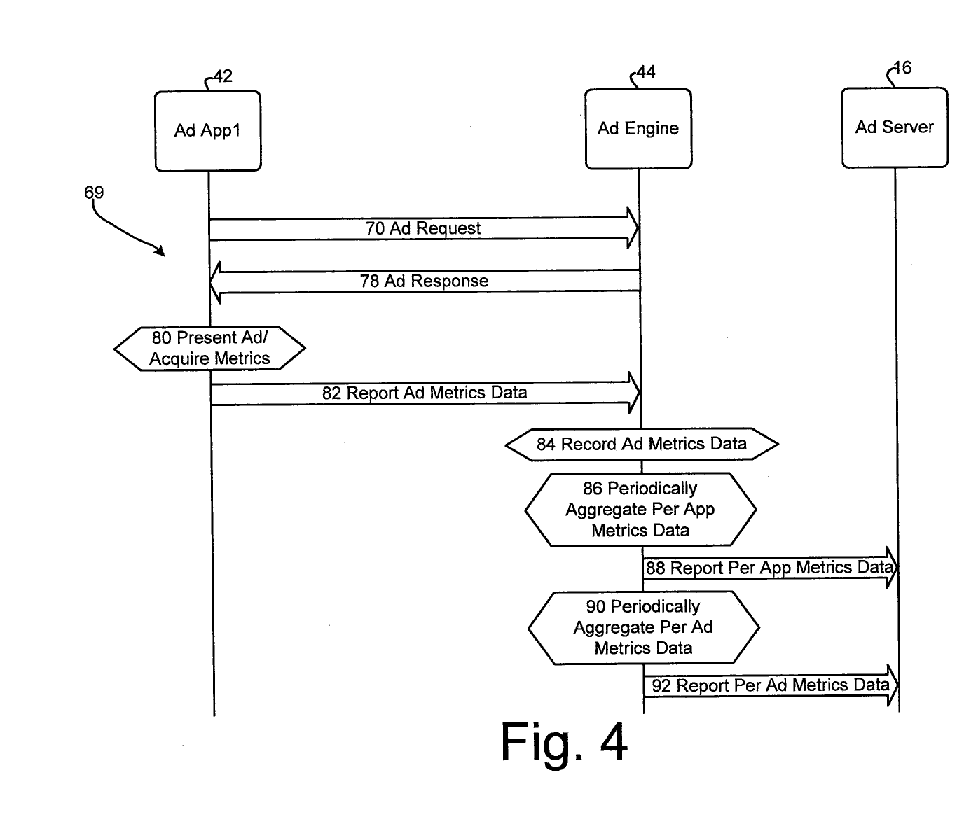

Referring now to FIG. 4, an exemplary diagram 69 that illustrates one embodiment of a message flow between Ad App1 42, Ad Engine 44 and an Ad Server 16 is provided. Message 70 indicates an Ad Request where Ad App1 requests an ad from Ad Engine 44. If Ad Engine 44 currently stores an ad reference corresponding to a suitable ad for presentation by Ad App1, Ad Response message 78 is returned to Ad App1 42 by the Ad Engine 44 where the message 78 includes the ad reference. Although not shown in FIG. 4, if Ad Engine 44 does not currently have a suitable ad stored for Ad App1 42, the Ad Engine 44 may request the ad reference or content from another source such as, for example from Ad Server 16. In response to the request, the server 16 or other source identifies a suitable ad for Ad App1 42 which is provided to Ad Engine 44. The ad reference is then provided to Ad App1 via Ad Response Message 78. Ad App1 42 uses the ad reference to obtain ad content from a content provider server 20 (FIG. 1) and then presents the ad. In an alternative, where the Ad Engine 44 caches ad content prior to use, the cached content may be provided via message 78.

As indicated by reference number 80, once ad content is obtained by Ad App1 42, the Ad App1 presents the ad and acquires metrics associated therewith. Ad App1 42 reports Ad Metrics Data to Ad Engine 44 via message 82 which may be referred to as an Ad App Metrics Report message. In an alternative, Ad App1 42 may simply present content and the Ad Engine 44 may be programmed to recognize specific user agent activity associated with Ad App1 as proxies or indicators that some activity associated with a metric has changed. For example, in instances when an ad is provided to Ad App1 42 to be presented along with application content where the content includes a link to additional content, where UA 12 is used to select the additional content link and the content request is routed through Ad Engine 44, the Ad Engine 44 may be programmed to recognize that the ad was viewed by the UA user and therefore that an “impression” was made. As indicated by reference number 84, Ad Engine 44 stores or updates metrics database 46 (FIG. 2) based on the receipt of message 82 or by recognizing UA activity associated with an Ad App (as described in the alternate embodiment, above). Referring still to FIGS. 1 and 4, as indicated by reference number 86, Ad Engine 44 periodically aggregates per application metrics data to form an Ad Engine Metrics Report. As indicated by message 88 which may be referred to as an Ad Engine Metrics Report, the per-application report is transmitted to Ad Server 16. As indicated by reference number 90, Ad Engine 44 periodically assembles a per-ad Metrics Report which is transmitted to Ad Server 16, as indicated by message 92. The periodic aggregation and transmission of per-app and per-ad metrics data may continue indefinitely at defined intervals or based on specific policy (e.g. established by the Ad Server 46)

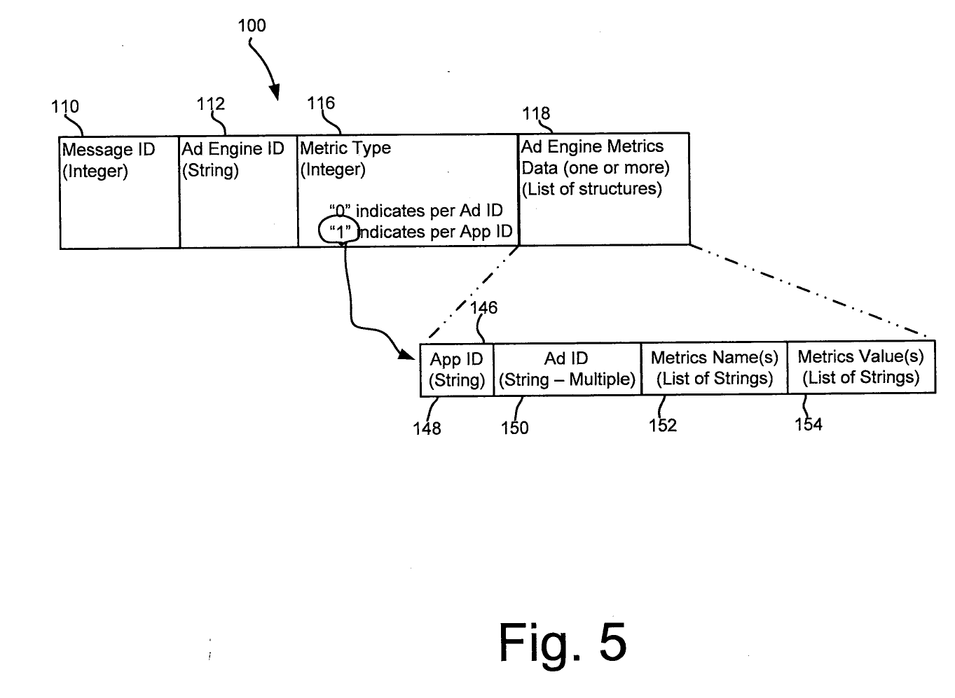

Referring to FIG. 5, an exemplary Ad Engine Metrics Report format 100 is illustrated. Report format 100 includes four fields 110, 112, 116 and 118 where field 118 includes four subfields 148, 150, 152 and 154. The format 100 includes a Message ID field 110, an Ad Engine ID field 112, a Metric Type field 116 and an Ad Engine Metrics data field 118. Message ID field 110 identifies messages related to the report and may consist of an integer type value. Ad Engine ID field 112 includes an identifier of the Ad Engine 44 that generates the report and may be in a character string form.

Metric Type field 116 indicates a type associated with the metric report because an Ad Engine 44 may be configured to generate at least two distinct types of Metrics Reports useful for different purposes. A first report type may be a per ad report to report metrics per advertisement. A second report type may be a per application report to report metrics on a per application basis. The same basic report structure shown in FIG. 5 can be used to generate both report types where the integer value in the metric type field distinguishes one report type from the other. The Metric Type field 116 may include an eight bit binary word capable of indicating any value between 0 and 255. Here, in the illustrated embodiment, a value “0” is used to indicate a per ad ID report type while a value “1” is used to indicate a per App ID report type. The other values 2-255 may be used for other purposes. For example, another value may be used to indicate that a report is a per campaign report, wherein a campaign is composed of a group of related advertisements.

In at least some cases hybrid report types may be generated and indicated via one of the other Metric Type values 2 through 255. For instance, the value 2 may indicate that a report includes some per ad ID metric data and some per-application metric data where the breakdown of per ad ID and per App ID data is know to both the Ad Engine 44 and a receiving Ad Server 16. Other metric type data divisions may be indicated via other Metric Type values. Moreover, a first bit in the eight bit Metric Type word may indicate either a per ad ID report (e.g., via a “0” designation) or a report that includes at least some per App ID data (e.g., via a “1” designation) where the second bit in the metric type byte indicates if the report is a pure per App ID report (e.g., via a “0” designation) or a hybrid report (e.g., via a “1” designation).

In other embodiments it is contemplated that metric type may be indicated via a first field in the Ad Engine metrics data section 118 of the report so that a separate metrics type field 116 is not necessary.

Referring still to FIG. 5, Ad Engine Metrics Data field 118 includes metrics data in the form of one or more lists of structures. In FIG. 5, where the Metric Type designation in field 116 indicates a per App ID report, Ad Engine Metrics Data field 118 includes a list of one or more structures, one per App ID reported, where one exemplary structure is labeled 146. Exemplary structure 146 includes an App ID field 148, an Ad ID field 150, a Metrics Name(s) field 152 and a Metrics Value(s) field 154. Field 148 indicates an App ID associated with the ad metrics data in the report and may include a character string. Field 150 indicates one or a plurality of ad IDs corresponding to each advertisement presented via the Ad App referenced in field 148. The ad IDs take the form of multiple strings. Field 152 lists names of metrics as strings for each of the ad IDs in field 150 and Metrics Value(s) field 154 includes a separate value for each App ID, ad ID and metric combination in columns 148, 150 and 152.

Referring still to FIG. 5, the order of fields in the Ad Engine Metrics Data section 146 of the report indicates a hierarchy of information where, in general, earlier fields in the format (i.e., fields that are earlier in the report) are at a higher or equal hierarchical level to fields later in the report. For instance, App ID field 148 comes before the Ad ID field 150 and is higher in the hierarchy of data so that there may be multiple instances of Ad IDs in the report associated with a single App ID (i.e. a 1-to-many relationship between App ID and corresponding Ad IDs in the report). Similarly, the Metrics Name(s) field 152 comes after the Ad ID field 150 and there may be multiple metrics names associated with each Ad ID included in the report (i.e. a 1-to-many relationship between Ad ID and Metrics Name(s) in the report). Metrics Value(s) field 154, while positioned lower than the Metrics Name(s) field, may be on the same hierarchical level. Thus, a report may include multiple Ad ID fields and a separate set of metrics names and values for each Ad App ID in the report. For instance, App ID field 148 may indicate Ad App1 and there may be four separate Ad ID fields 150, a separate field 150 for each of four ads presented via a UA 12 via Ad App1 so that a report includes metrics associated with four distinct Ad App/Ad ID combinations. For each combination a set of metrics names and values would be included in the report.

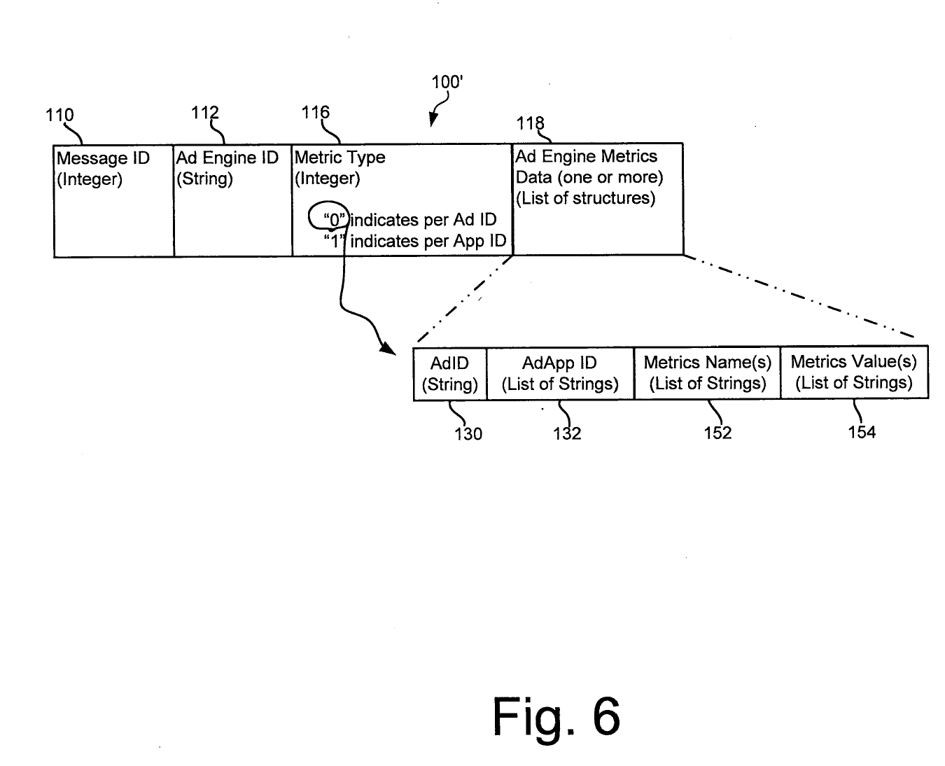

Referring to FIG. 6, another report format 100′ is illustrated. As shown, when the Metric Type field 116 includes a “0” value the report is a per ad ID type such that the Ad Engine Metrics Data field 118 includes subfields 130, 132, 152, 154 corresponding to a per ad ID report. In format 100′, fields 110, 112, 116, 152 and 154 are similar to the identically numbered fields described above with respect to FIG. 5 and therefore will not be described here again in detail.

The primary difference between format 100 (FIG. 5) and 100′ (FIG. 6) is that in format 100′, the Ad ID field 130 is at a higher hierarchical level than the Ad App ID field 132 meaning that there is only one Ad ID for each Ad Engine Metrics Data field 118 and there may be multiple Ad App IDs per field 118. In this case, in at least some embodiments, as seen in field 132, the Ad App IDs are presented as a list of strings. Thus, for instance, where five different applications were used to present an ad, the list of strings would simply indicate the application names or identities used to present the ads as a group and metrics name(s) and value(s) reported in fields 134 and 136 would be related to the ad generally and not to specific ad Ad/App ID combinations (i.e., the metrics could not be broken down by application and instead could only be associated with an ad).

Also the per Ad report type can be used by the Ad Engine to report information about an Ad that was not pass to an Ad App. For instance, where Ad Engine 44 pre-fetches an Ad with characteristics that are never met by Ad App; the Ad Engine never passes the Ad to an Ad App and the Ad expires. Where an Ad expires, field 132 may be empty and the metrics name/value might be “not used”, “expired” or “removed” indicating that the Ad has been removed from the cache without being used (i.e. played, presented or otherwised displayed to the user).

As another instance, the Ad Engine 44 may pass an Ad to an Ad App but the Ad App may not provide any metrics data associated with the Ad. Failure to report metrics can occur when an application is closed before the Ad is displayed. In this case, the per AD report type may be used to indicate the Ad App that the Ad was provided to (i.e., fields 130 and 132 are used in the usual fashion to indicate an Ad and Ad App) while the metrics names/values may indicate that the Ad Engine did provide the Ad to the corresponding Ad App but that no metrics were provided by the Ad App.

In an alternative, in some embodiments the per Ad Metrics Report may include metrics that correspond to specific Ad/Ad App ID combinations where metrics are associated with specific Ad Apps as well as specific ads. This may be accomplished by providing Ad App IDs as multiple independent strings in sub-field 132 in a fashion akin to the way Ad IDs are presented in field 150 shown in FIG. 5.

Regarding periodicity of the different report types (e.g., the per ad ID report and the per Ad App ID report), the periods may be selected to be any duration of interest. For instance, each report may be generated daily, weekly or monthly, for each Ad ID and/or for each Ad App ID. In at least some cases the report types will have different periodicity. For instance, in at least some cases the per Ad ID report will be generated every day while the per Ad App ID report will be generated on a weekly basis. In some cases the system may be programmed so that the reporting periods are known by the Application Server 16. In other cases an additional field could be provided a report such as a time field indicating the period of the report (daily/weekly) or indicating the last time since such report was sent. In still other cases, the metric type field may be used to indicate both report type and the period of the report. For instance, a “0” may indicate a daily per ad report, a “1” may indicate a weekly per ad report, a “2” may indicate a daily per Ad App report and a “3” may indicate a weekly per Ad App report.

Referring again to FIG. 1, in at least some cases, instead of Ad Apps running on a UA 12 and being monitored by an Ad Engine, SP server 20 may perform many of the tasks associated with the Ad Engine 44 described above and may run SP Apps to provide services via UA 12. To this end, the SP Apps and/or SP server 20 may report metrics on at least one of a “per ad” and “per app” basis to the Ad Server 16. Exemplary SP Apps may include combinations of streaming media services, MMS services, SP-portal services, etc.

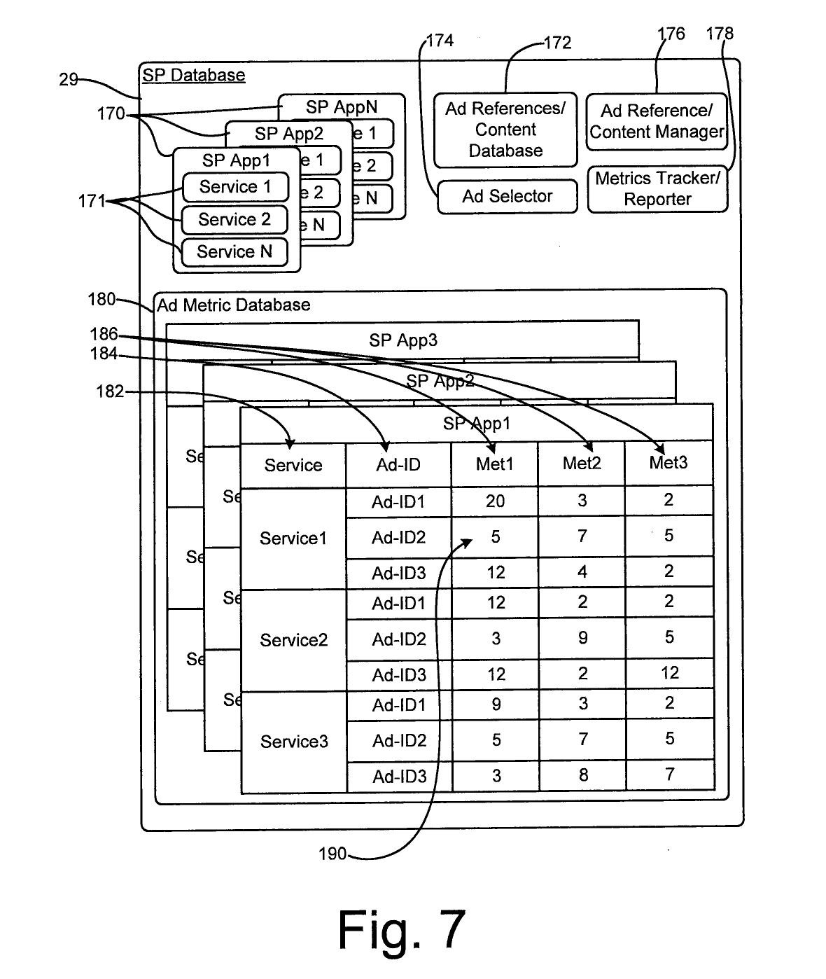

Referring now to FIGS. 1 and 7, SP Server 28 is linked to an SP database 29. As shown in FIG. 7, SP database 29 that stores several different types of information including Sp Apps collectively identified by reference numeral 170 that are run by server 20. In addition, database 29 stores an Ad References/Content Database 172, an Ad Selector 174, an Ad Reference/Content Manager 176, a Metrics Tracker/Reporter 178 and an Ad Metric Database 180. Each of the Ad References/Content Database 172, Ad Selector 174 and Ad Reference/Content Manager 176 perform functions that may be substantially similar to the functions described above with respect to the similarly labeled components in FIGS. 2 and 3 and therefore those functions and related methods will not be described again here in detail. It should suffice to say that components 172, 174 and 176 cooperate to obtain advertisements that are suitable for presentation to a UA user via the SP Apps 170 and provide those ads or ad references to an SP App whenever the SP App should present an ad. The SP Apps 170 receive ads, embed the ads in content associated with specific services, and provide the content and ads via a service to UA 12. When UA 12 receives service content and ads from an SP App 170, UA 12 presents the content as part of the service along with the ad.

After service content and an ad have been transmitted to UA 12, Metrics Tracker/Reporter 178 monitors the wireless network for communications associated with the provided service that indicate that the ad was presented via the UA 12. For instance, where content provided includes a link to additional content, it can be presumed that an ad that was to be presented along with the content was in fact presented (i.e., an impression occurred) when the SP server 28 receives a request for more content associated with the link (i.e., once the link has been selected). When a link for more content is selected and the request is received by server 28, server 28 obtains the requested content and may bundle another ad with the content prior to transmitting the content back to the UA 12 for presentation. In addition, where agent activity (i.e., link selection) indicates that an ad was presented, when the request for more content associated with the link is received at the server 28, the server may store an indication in the ad metrics database 180 that the ad was presented.

In at least some embodiments the SP server 28 may be programmed to modify the ad-link path for links in an advertisement that can be clicked so that when selected, requests for more advertisement information are routed back through SP server 28 prior to transmission to an entity addressed in the original link. In this way, the SP server Metrics Tracker/Reporter 178 (see FIG. 7) may be able to track metrics in addition to impressions.

Referring still to FIG. 7, Ad Metric Database 180 includes a separate data table or data structure for each SP App 170 run by SP server 28 where three separate tables are labeled SP App1, SP App2 and SP App3. The Sp App tables are similarly configured and therefore, in the interest of simplifying this explanation, only the SP App1 table is described here in detail. The SP App1 table includes a service column 182, an Ad-ID column 184, and one or more metrics columns collectively identified by numeral 186. Service column 182 lists all services associated with SP App1 that may present an advertisement via a UA pursuant to service activities. While only three services are listed as Service1, Service2 and Service3 in the exemplary table, an SP App may have any number of associated services.

Referring still to FIG. 7, Ad-ID column 184 lists a plurality of ad IDs corresponding to advertisements presented at least once for each service in column 182. In the illustrated table, column 184 includes three separate Ad-IDs for each of the services in column 182. The metrics columns 186 each correspond to a different ad metric that may be tracked by the SP server 28 and each column includes a metrics value corresponding to each service-Ad-ID combination in columns 182 and 184. Thus, for instance, where Met1 corresponds to the number of times an ad was presented via a service, where server 28 determines that Service1 was used to present or display the ad corresponding to Ad-ID2, server 28 increments the value in field 190 in FIG. 7 to reflect the additional presentation.

According to at least one aspect of the present invention, Metrics Tracker/Reporter 178 in FIG. 7 is configured to periodically assemble SP application ad Metrics Reports per SP App service where the reports include at least some information about which services presented which ads. These Metrics Reports may be stored, for example by the metrics tracker/reporter 178, on a computer readable storage medium which in some instances may be a tangible or intransitory medium such as optical (e.g., CD, DVD, etc.), magnetic (e.g., tape) or other memory known in the art. Here, as in the case of the Ad Engine reports described above, the information indicates which services presenting ads have the greatest penetration or response, given different types of advertisement campaigns. For instance, where a specific ad or campaign was presented 300 times via Service1 and 100 times each via Service2 and Service3, respectively, via multiple UAs and over a tracking period, ad relevancy and penetration/response associated with the service may be divided 60%, 20% and 20% for the providers of Service1, Service2 and Service3, respectively. Similarly than for the ad app cases, the analysis may be used to divide up and associate revenue amongst service providers when an SP App hosts services from different service providers.

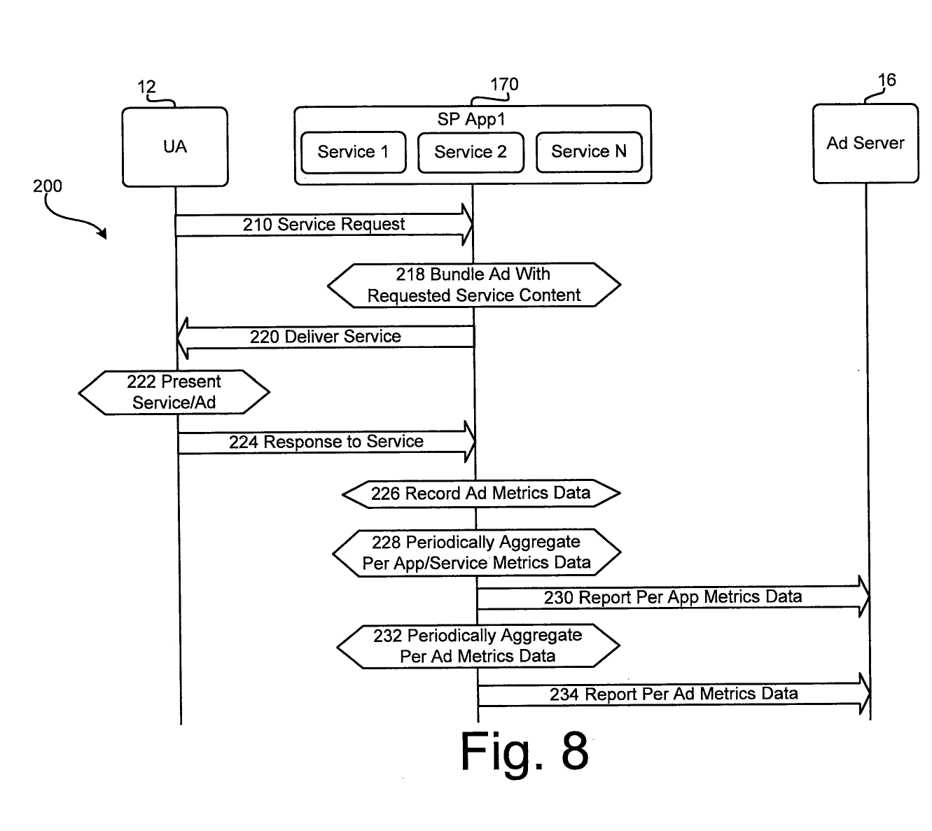

Referring now to FIG. 8, an exemplary diagram 200 that illustrates one embodiment of a message flow between a UA 12, Sp App1 170 and an Ad Server 16 is illustrated. As indicated by message 210, UA 12 communicates a Service Request to SP App1 170. When SP App1 170 receives a service request, SP App1 identifies content for the service and whether or not an ad is to be included with the service. Where an ad is to be included, if a suitable ad is already cached in database 172 (see FIG. 7), the ad is retrieved and bundled (as indicated by reference number 218) with the content for delivery to the requesting UA 12. If a suitable ad is not cached in database 172, the SP server 28 obtains suitable ad content from a content provider (e.g., CP Server 20 in FIG. 1) and bundles the ad with the service content at 218. Message 220 indicates a Delivery Service message whereby the content and ad are delivered to UA 12.

Reference number 222 indicates that the UA 12 presents the content and ad. Message 224 indicates a Response to Service message when the user interacts with the content to access additional content. That is, the interaction results in a response to service being transmitted back to SP App1. SP App1 recognizes the response as an indication that the advertisement has been presented and updates the ad metrics data, appropriately, as indicated by reference number 226. In some cases, the UA may report the ad interaction that occurred in message 224. Where advertisement links in the presented ad have been modified to link through SP server 28 when selected, any clicking on advertisement links is also detected by metrics tracker/reporter 178 at server 28 and is used to update corresponding metrics. Referring again to FIGS. 1 and 8, as indicated by reference number 228, SP App1 170 periodically aggregates per service metrics data to form an SP App Metrics Report and communicates message 230 such that the report is transmitted to Ad Server 16 (FIG. 1). Reference number 232 indicates that SP App1 periodically assembles a per ad Metrics Report which is transmitted to Ad Server 16 via message 234.

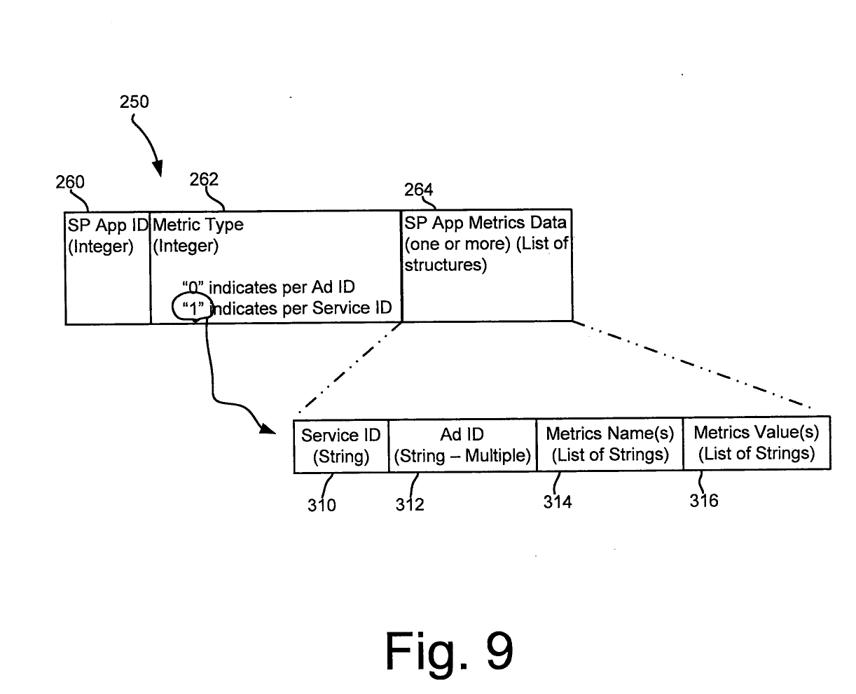

Referring to FIG. 9, an SP App metrics data report format 250 is illustrated which has a format that may be substantially similar to the Ad Engine Metrics Report format 100 described previously with respect to FIG. 5. Format 250 includes an SP App ID field 260, a Metric Type field 262 and an SP App Metrics Data field 264 where field 264 includes another set of fields where the set is dependent upon a metric type indicator that is populated or otherwise included in field 262.

Field 260 indicates an SP App ID corresponding to a specific SP App. The value in field 260 may be an integer. Field 262 is akin to field 116 in FIG. 5 and may indicate any value between 0 and 255. Here, a “0” designation in field 262 indicates a per ad ID report type while a “1” designation indicates a per service ID report type.

Referring still to FIG. 9, field 264 includes SP App Metrics Data. In instances when field 262 indicates a per Service ID report type (e.g., field 262 includes a “1” designation), metrics data 264 includes, as shown in FIG. 9, a Service ID field 310, an Ad ID field 312, a Metrics Name(s) field 314 and a Metrics Value(s) field 316. Service ID field 310 contains a service identifier (e.g. a service identifier registered as part of service description within the Open Mobile Alliance Naming Authority OMNA service identifier such as ‘org.openmobilealliance:PoC-Alert’) indicating a specific service used to present advertisements for which metrics are provided in the report. Ad ID field 312 indicates each advertisement by unique ID string that was presented during a tracking period using the service indicated in field 310. Here, the Ad ID field 312 may include one or multiple separate strings (optionally delimited by a space character or some other special token character), one for each Ad ID associated with a presented advertisement. Metrics Name(s) field 314 and Metrics Value(s) field 316 provide ad metrics names and values for each of the Service ID and Ad ID combinations indicated in fields 310 and 312 as lists of strings.

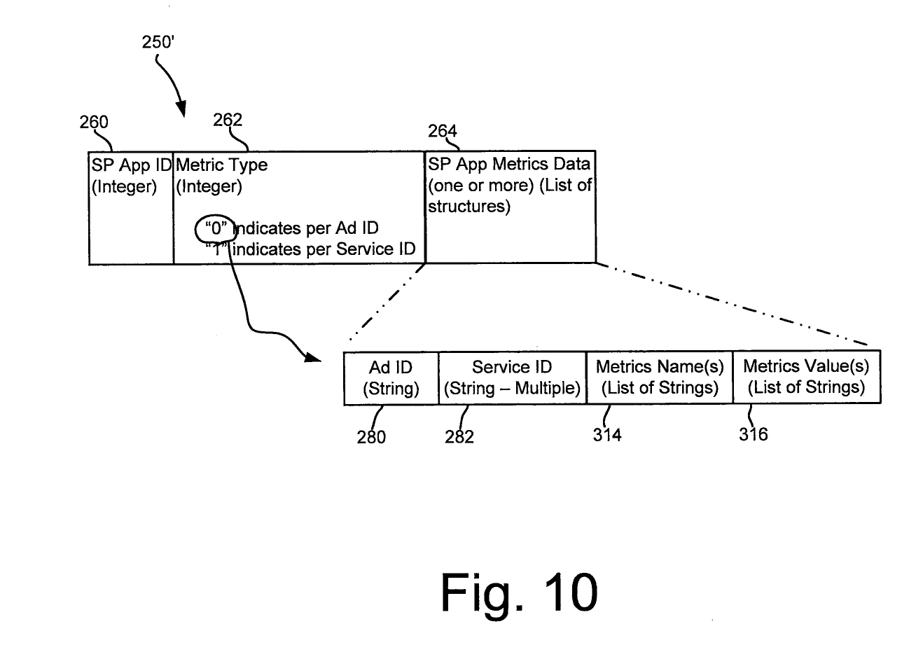

Referring to FIG. 10, an exemplary SP App metrics data per ad ID report format 250′ is illustrated. In FIG. 10, fields 260, 262, 264, 314 and 316 are similar to the identically marked fields in FIG. 9 and therefore will not be described again here in detail. The primary difference between format 250′ and format 250 (FIG. 9) is that format 250′ includes an Ad ID field 280 prior to a Service ID field 282 where multiple service IDs (i.e., multiple strings) may be associated with a single Ad ID in field 280. Thus, in FIG. 10, reporting is on a per advertisement basis as opposed to a per SP App service basis.

Where SP server 28 reports metrics to Ad Server 16, as in the case of Ad Engine 44 (FIG. 4) described above, the periods for reporting may be selected as desired. Per ad reports and per SP App service reports may be reported at the same times or may have different periodicity.

Furthermore, the Ad Server 16 may notify Ad Engine 44 and the SP Apps 170 of an expected frequency at which given metric types are expected. This service provider policy can be set-up at provisioning, registration steps or via other means (e.g. through local policy). In one particular embodiment, the Ad Server 16 and the Ad Engine/SP App may exchange rules. Rules can be requested by the Ad Engine/Sp App or can be pushed by the Ad Server 16. Such a rule set can be part of a dedicated message flow or can be appended to an existing message (e.g. an Ad Response message).

The following is an exemplary XML based rule set where the first rule defines that a weekly frequency of metrics data to be reported per application while the second rule defines that a daily frequency of metrics data to be reported by Ad IDs:

```
<?xml version=“1.0”?>
<mobad:ruleset xmlns:mobad=“urn:rim:params:xml:ns:advertising-rules”
  xmlns:xsi=“http://www.w3.org/2001/XMLSchema-instance”
  xsi:schemaLocation=“urn:rim:params:xml:ns:advertising-rules”>
  <mobad:rule id=“ad_rule1”>
    <mobad:metricReports>
      <mobad:metricReport id=“com:rim:bb:appstore:mr:appId”
      active=“true”>
            <mobad:mrFrequency><mobad:WEEKLY/>
            </mobad:mrFrequency>
          <mobad:mrType><mobad:MR_BY_APPID/>
          </mobad:mrType>
          <mobad:appID>com.rim.bb.appstore</mobad:appID>
        </mobad:metricReport>
            <mobad:metricReport id=“com:rim:bb:mr:adID”
            active=“true”>
            <mobad:mrFrequency><mobad:DAILY/>
            </mobad:mrFrequency>
          <mobad:mrType><mobad:MR_BY_AD_ID/>
          </mobad:mrType>
            </mobad:metricReport>
        </mobad:metricReports>
  </mobad:rule>
</cp:ruleset>
```

The present invention has been described in terms of the various aspects and features, and it should be appreciated that many equivalents, alternatives, variations, and modifications, aside from those expressly stated, are possible and within the scope of the invention. Therefore, the invention should not be limited to a particular described embodiment.

1. A method comprising:
receiving, at an advertising entity, a report message containing an identifier of an application which presented advertisements, and a data structure with metrics for the advertisements which were presented by the application.

2. The method of claim 1 wherein the advertising entity is an Ad Engine and the application is an Ad App as specified by the Open Mobile Alliance (OMA) Mobile Advertising (MobAd) enabler.

3. The method of claim 2 wherein the report message is an Ad App Metrics Report message.

4. The method of claim 2 further comprising:
communicating, to an Ad Server as specified by the Open Mobile Alliance (OMA) Mobile Advertising (MobAd) enabler, an Ad Engine Metrics Report message which includes information of the report message.

5. The method of claim 4 wherein communicating comprises:
creating a metric report by aggregating the information of the report message with additional metric data; and
sending the Ad Engine Metrics Report message which includes the metric report.

6. The method of claim 5 wherein the additional metric data is from one of: another application which presented advertisements; the Ad Engine; and a component of a device on which the Ad Engine is configured.

7. The method of claim 1 wherein the advertising entity is an Ad Server and the application is a service provider (SP) application (SP App) as specified by the Open Mobile Alliance (OMA) Mobile Advertising (MobAd) enabler.

8. The method of claim 7 wherein the report message is an SP App Metrics Report message.

9. An electronic device comprising:
an advertising entity configured to receive a report message containing an identifier of an application which presented advertisements on the electronic device, and a data structure with metrics for the advertisements which were presented by the application.

10. The electronic device of claim 1 wherein the advertising entity is an Ad Engine and the application is an Ad App as specified by the Open Mobile Alliance (OMA) Mobile Advertising (MobAd) enabler.

11. The electronic device of claim 10 wherein the report message is an Ad App Metrics Report message.

12. The electronic device of claim 10 wherein the advertising entity is further configured to:
communicate, to an Ad Server as specified by the Open Mobile Alliance (OMA) Mobile Advertising (MobAd) enabler, an Ad Engine Metrics Report message which includes information of the report message.

13. The electronic device of claim 12 wherein the advertising entity, when communicating, performs operations of:
creating a metric report by aggregating the information of the report message with additional metric data; and
sending the Ad Engine Metrics Report message which includes the metric report.

14. The electronic device of claim 13 wherein the additional metric data is from one of: another application which presented advertisements; the Ad Engine;
and a component of a device on which the Ad Engine is configured.

15. The electronic device of claim 9 wherein the advertising entity is an Ad Server and the application is a service provider (SP) application (SP App) as specified by the Open Mobile Alliance (OMA) Mobile Advertising (MobAd) enabler.

16. The electronic device of claim 15 wherein the report message is an SP App Metrics Report message.

17. A method comprising: receiving, at an advertising server from an advertising engine on an electronic device, a report message containing an identifier of an application on the electronic device which presented advertisements, and a data structure with metrics for the advertisements which were presented by the application.

18. The method of claim 17 wherein the advertising server is an Ad Server as specified by the Open Mobile Alliance (OMA) Mobile Advertising (MobAd) enabler, wherein the advertising engine is an Ad Engine as specified by the OMA MobAd enabler, and wherein the application and the application is an Ad App as specified by the OMA MobAd enabler.

19. The method of claim 18 wherein the report message is an Ad Engine Metrics Report message.

20. A network device comprising:
an advertising server configured to receive, from an advertising engine on an electronic device, a report message containing an identifier of an application on the electronic device which presented advertisements, and a data structure with metrics for the advertisements which were presented by the application.

21. The network device of claim 20 wherein the advertising server is an Ad Server as specified by the Open Mobile Alliance (OMA) Mobile Advertising (MobAd) enabler, wherein the advertising engine is an Ad Engine as specified by the OMA MobAd enabler, and wherein the application and the application is an Ad App as specified by the OMA MobAd enabler.

22. The network device of claim 21 wherein the report message is an Ad Engine Metrics Report message.
